(19) United States
(12) Patent Application Publication
(10) Pub. No.: US 2015/0278867 A1
(43) Pub. Date: Oct. 1, 2015

(54) BEACON DEVICE FOR ENHANCING MEASUREMENTS OF THE EFFECITIVENESS OF MOBILE NOTIFICATIONS

(71) Applicant: Yext, Inc., New York, NY (US)

(72) Inventors: Howard C. Lerman, New York, NY (US); Thomas C. Dixon, New York, NY (US); Kevin Caffrey, New York, NY (US)

(21) Appl. No.: 14/670,992

(22) Filed: Mar. 27, 2015

Related U.S. Application Data
(60) Provisional application No. 61/972,867, filed on Mar. 31, 2014.

(51) Int. Cl. G06Q 30/02; H04W 40/24; H04W 4/00; H04W 4/02; H04W 76/02

(52) U.S. Cl. CPC G06Q 30/0261; H04W 4/02; H04W 76/023; H04W 4/008; H04W 40/244; H04W 84/12

(57) ABSTRACT

A beacon device comprising a memory, a processor, and one or more first wireless transceivers is disclosed. The processor retrieves, from the memory, a list of entries of identification information related to a plurality of entities. The processor selects the one or more first wireless transceivers. The processor divides the list of entries of identification information into one or more sub-lists. Each of the one or more sub-lists corresponds to a selected one of the first wireless transceivers. The processor instructs the selected one or more first wireless transceivers to repeatedly cycle through broadcasting each of the entries in the designated sub-list in successive first time intervals. The transmitted entries are to be received and to be processed by one or more receiving devices in a second time interval equal to or greater than a minimum beacon broadcast interval.

### CROSS-REFERENCE TO RELATED APPLICATIONS

This application claims the benefit of U.S. provisional patent application No. 61/972,867 filed Mar. 31, 2014, the disclosure of which is incorporated herein by reference in its entirety.

### TECHNICAL FIELD

The invention relates generally to location-based services, and more particularly, to a system comprising a hardware beacon device, a mobile software application, a management server of the beacon hardware device, and a reporting platform and application for detecting the presence of the beacon hardware device. The system enhances measurements of the effectiveness of notifications (e.g., advertisements) in driving users (e.g., customers) having mobile devices to physical location (e.g., store locations) associated with advertisers.

### BACKGROUND

iBeacon technology from Apple has focused on enhancing in-store experiences for customers using mobile applications (hereinafter “apps”). Leveraging Bluetooth Low Energy—also known as Bluetooth Smart—and the iBeacon technology, a low-powered, low-cost transmitter (hereinafter “beacon”) can establish a physical region around the beacon. Apps, running on nearby devices that support BLE, may be programmed to listen for specific iBeacon signals to determine whether the devices have entered or left the established region.

A group of well-placed beacons, broadcasting iBeacon signals, may be used to pinpoint locations of users in a store. An app may be programmed to deliver location and context-aware messages to consumers. For example, the app may be programmed to alert consumers of items nearby that are on sale, or items that consumers are looking for.

Leveraging BLE and the iBeacon technology, the beacon transmits a unique identifier, which may be sensed by a compatible app or operating system of a mobile device that may trigger an action on the mobile device such as providing a coupon by the clothing section of the store.

While much of the discussion around the iBeacon technology has focused on its use to enhance in-store experiences for consumers using mobile apps, it is also possible for mobile ad networks/platforms to leverage the iBeacon technology to measure online-offline conversions of their mobile ads. A beacon may be placed in a physical location, broadcasting an iBeacon signal that a mobile ad-platform/network (such as Facebook) uniquely assigns to the location. A mobile app, which had previously shown a user a mobile ad—served by the mobile-ad platform/network—intended to drive the user to a physical location, receives the iBeacon signal that is associated with the intended location, and reports the visit back to the mobile ad platform/network. The mobile ad-network can then record the in-store visit, and measure the effectiveness of the mobile ad. Such a setup requires coordination among the mobile ad network/platform, the beacon device vendor, and the advertiser; the setup is tedious and error-prone. For each ad-network/platform with which the advertiser wants to advertise, a beacon must be set up to broadcast a unique identifier assigned by the mobile ad-network/platform. For the ad-network and platform, it is difficult to source, program, and track, various beacons that have been sent to advertisers. For ad-networks that do not necessary have their own mobile apps, it is difficult for the ad-networks to source their unique identifiers to 3^{rd} party app developers who are placing mobile ads that they received from the ad-networks.

### SUMMARY

A hardware beacon device, a beacon management server, a beacon detection reporting server, and a mobile application software development kit (SDK) are disclosed. The problem of needing different beacons, each broadcasting a beacon signal uniquely associated with a location pre-assigned by a mobile ad network or platform, may be remedied and a technical solution may be achieved in the art, by providing a single beacon device (hereinafter an “attribeacon device”) that is programmed to simulate substantially simultaneously the broadcast of many different beacon signals. The attribeacon device comprises a memory, a processor, and one or more first wireless transceivers (e.g., one or more Bluetooth radios). The processor may be configured to retrieve, from the memory, a list of entries of identification information related to a plurality of entities (e.g., an advertiser, a business, an organization, a government agency, etc., e.g., users of attribeacon devices who desire to advertise on multiple ad-networks/platforms).

In one example, each entry in the list of identification information may comprise a field for storing an identifier (e.g., a proximity universal unique identifier (UUID)) of a server that manages an individual entity in the list (e.g., a reporting server, e.g., to manage an advertisement campaign for an advertiser on an advertisement platform server). Each entry in the list of identification information may further comprise a field for storing an identifier (e.g., a major value, major identifier, or major ID) of an entity (e.g., an advertiser, a business, an organization, a government agency, etc.). Each entry in the list of identification information may further comprise a field for storing an identifier (e.g., a minor value, a minor identifier, or minor ID) that identifies location information related to the attribeacon device (e.g., the physical location of the attribeacon device, e.g., in latitude/longitude coordinates, e.g., a store location). The location information related to the attribeacon device may be a physical location of the attribeacon device (e.g., in a store of an advertiser) or a portion of the physical location of the attribeacon device (e.g., a specific department of the store). In another example, the Major ID and Minor ID may be combined into entity-location pairs to identify the location information related to the attribeacon device (e.g., a store location).

The processor may be further configured to select the one or more first wireless transceivers. In one example, the processor may be further configured to divide the list of entries of identification information related to the plurality of entities into sub-lists, one sub-list corresponding to each selected one or more first wireless transceivers. The processor may be further configured to instruct the selected one or more first wireless transceivers to repeatedly cycle through broadcasting each of the entries in the designated sub-list in successive first time intervals. The transmitted entries are to be received and to be processed by one or more receiving devices in a second time interval, i.e., a minimum required beacon broadcast interval. In an example, the first-time interval may be longer than the minimum required beacon broadcast interval (second time interval), such that the transmitted entries may be received and processed by nearby receiving devices as simultaneous and independent beacon signals that are associated with different beacon devices. In another example, the minimum required beacon broadcast interval may be equal to or greater than a sum of the successive first time intervals in the list of entries.

To program and further operate the attribeacon device by an attribeacon management server, the attribeacon device may further comprise a second wireless transceiver (e.g., a Wifi radio). The second wireless transceiver may be configured to receive from the attribeacon management server, the list of entries of identification information related to the plurality of entities. The second wireless transceiver may be configured to transmit to the processor, the list of entries of identification information related to a plurality of entities. The processor may store in the memory, the list of entries of identification information related to the plurality of entities.

To program and further operate the attribeacon device to add to or delete additional identification information related to additional entities from the list by an attribeacon management server, the second wireless transceiver may receive from the attribeacon management server, one or more additional sets of identification information related to one or more corresponding additional entities to be added to or deleted from the list. The second wireless transceiver may transmit to the processor, the one or more additional sets of identification information related to the one or more corresponding additional entities. The processor may add to or delete from the list, the one or more additional sets of identification information related to the one or more corresponding additional entities to produce an updated list. The processor may repeat said retrieving, said selecting, and said instructing for the updated list.

In an example, the attribeacon device may be agnostic as to its own location. When an attribeacon device first arrives at a location, a companion app may be employed by an advertiser (e.g., user) to inform the attribeacon management server that the attribeacon device is at a certain location (previously defined in the attribeacon management server). The attribeacon device may be configured to receive these UUID/major values/minor values, and simulate the simultaneous broadcast of them. Additionally, attribeacon devices may be configured to broadcast different ids.

The above-described problems are remedied and a technical solution is achieved in the art by providing a method for an attribeacon application (e.g., an app) running on a mobile device of a user of the mobile device to detect and process identification information related one or more of a plurality of entities broadcast by an attribeacon device, and to report the processed identification information to a server that manages the identification information (e.g., a reporting server). A processor of the mobile devices may execute an application (e.g., an attribeacon app) of the mobile device having an identification information (e.g., a platform-specific identifier (IDFA), e.g., a Twitter handle or a Facebook or email login identifier) that identifies the user of the mobile device or identifies the mobile device. The processor may retrieve from the attribeacon app, the identification information that identifies the user of the mobile device or identifies the mobile device. The processor may transmit to the reporting server, the identification information that identifies the user of the mobile device or identifies the mobile device as an indication that the processor has registered with the reporting server.

The attribeacon app may request from the reporting server, a notification (e.g., an advertisement) related to the entity (e.g., an advertiser). The application app may instruct the processor to display the notification related to the entity on a display of the mobile device.

The application app may receive from the reporting server, a set of identifiers to be broadcast by the attribeacon device. The attribeacon app may register with the processor the set of identifiers in a list of identifiers pertaining to identification information related to the plurality of entities. If the app is sleeping, when the processor detects the presence of a beacon signal having one of the set of identifiers in a list of identifiers, the app is “awakended” to process the received signal. If the app is currently active, the app simply processes the received signal.

In an example, when awakended, the attribeacon app may receive a first identifier (e.g., a proximity UUID) broadcast by the attribeacon device that pertains to identification information related to an entity. The application app may determine whether the first identifier is in the list of identifiers (e.g., proximity UUIDs) pertaining to identification information related to a plurality of entities for which the attribeacon app has registered to receive notification information related to the entity. If the attribeacon app identifies the first identifier in the list of identifiers, then the attribeacon app permits receiving one or more additional identifiers broadcast by the attribeacon device, the one or more additional identifiers (e.g., major ID and minor ID) associated with the first identifier and pertaining to identification information related to the entity. The attribeacon app may transmit the first identifier and the one or more additional identifiers associated with the first identifier to the reporting server.

If the attribeacon app does not identify the first identifier in the list of identifiers, then the attribeacon app does not permit receiving the one or more additional identifiers broadcast by the attribeacon device. In an example, the attribeacon app repeats the above steps for any remaining first-type identifiers (e.g., proximity UUIDs) broadcast by the attribeacon device.

The above-described problems are remedied and a technical solution is achieved in the art by providing a method for a server (e.g., a beacon management server) that (a) keeps a record of locations of attribeacon devices, (b) authorizes ad platforms/networks (e.g., reporting servers) access to the attribeacons, devices and (c) facilitates the programming of the attribeacon devices.

In one example, the beacon management server may be configured to receive location information of deployed attribeacon devices (i.e., which attribeacons are associated with which physical stores, or regions within stores). The beacon management server also receives requests (from the entity, e.g., advertisers) to authorize one or more reporting servers (e.g., ad-platforms/networks) access to the attribeacon devices. The beacon management server transmits to the authorized ad-platforms/networks the list of locations, and receives (from the reporting servers, e.g., ad-platforms/networks) the list of UUID/major/minor values for the corresponding list of locations. The beacon management server configures an attribeacon device with the appropriate UUID/major/minor values that identify the location and reporting servers (e.g., ad-platforms/networks).

In another example, instead or receiving the actual UUID/major/minor values from an authorized reporting server (e.g., ad-platform/network), the beacon management server may receive a beacon configuration scheme (i.e., how UUID/major/minor values should be assigned to locations) from the reporting server (e.g., ad-platform/network). The beacon management server then creates the UUID/major/minor values, which conforms to the beacon configuration scheme, programs an attribeacon device with the appropriate UUID/major/minor value for the reporting server (e.g., ad-platform/network), and transmits the list of locations and UUID/major/minor values back to the reporting server (e.g., ad-platform/network).

In one example, the beacon management server receives instructions to de-authorize a reporting server (e.g., ad-platform/network). The beacon management server transmits instructions to associated attribeacon devices (which had been broadcasting the reporting server's (e.g., ad-platform/network's) UUID/major/minor values) to stop broadcasting the reporting server's (e.g., ad-platform/network's) identifier. Additionally, the beacon management server communicates to the reporting server (e.g., ad-platform/network) that the reporting server (e.g., ad-platform/network) no longer has access to the associated attribeacon devices.

In one example, the beacon management server receives instruction to authorize a new reporting server (e.g., ad-platform/network). The beacon management server transmits the list of locations to the reporting server (e.g., ad-platform/network), and receives from the ad-platform/network either the list of identifiers (or configuration schemes to create the identifiers). The beacon management server transmits add instruction (with the ad-platform/network's identification values) to all active attribeacon devices.

In one example, the beacon management server retains open communications with all active attribeacon devices. The beacon management server monitors whether the attribeacon devices are behaving appropriately and reinstates those that are not behaving appropriately.

In another example, an attribeacon devices periodically pings the beacon management server (as a way to indicate that attribeacon device is still behaving appropriately). The beacon management server may reinitiate those attribeacon devices that have not pinged the server in an extended amount of time.

In one example, the beacon management server receives activation instruction for a new attribeacon device (and its location information). The beacon management server transmits the location information to all currently authorized reporting servers (e.g., ad-platform/networks), obtains the UUID/major/minor values, and programs the newly activated attribeacon device. In one example, the beacon management server receives instruction to deactivate a set of existing attribeacon devices. The beacon management server communicates the deactivation requests to all currently authorized reporting servers (e.g., ad-platform/networks) and removes the corresponding UUID/major/minor values form their memories.

The above-described problems are remedied and a technical solution is achieved in the art by providing a method for a reporting server that reports (a) those consumers who have been served and seen the ads, and (b) those consumers who have entered the regions monitored by beacons. The reporting server may be configured to cross correlate (a) and (b) to determine which consumers have both seen the ads and visited a location, thereby, closing a loop in the overall system.

In an example, the reporting server may receive from an application, which had been programmed to listen for the reporting server (ad-platform/network)-specific identifiers, running on the mobile device, identification information identifying a user of the mobile device or the mobile device. The reporting server may receive from the app, identification information associated with an attribeacon device. The reporting server may determine whether the beacon identification information is associated with an existing advertisement campaign that has attribeacon devices assigned to it. The reporting server decides whether the user is in the list of users who have seen the advertisement that is associated with the campaign. If the identification information identifying the user of the mobile device or the mobile device corresponds to a user or a mobile device registered to receive notification information that has seen a location-specific advertisement, then the reporting server may associate in a data store the location-specific advertisement with the user or the mobile device registered to receive notification information. Otherwise, the reporting server does not form an association in a data store.

In an example, the identification information identifying a user of the mobile device or the mobile device may be a platform-specific identifier (IDFA). In an example, the identification information identifying a user of the mobile device or the mobile device may serve as a registration request by the user of the mobile device or the mobile device to receive the notification information related to the entity.

### BRIEF DESCRIPTION OF THE DRAWINGS

The present invention may be more readily understood from the detailed description of examples presented below presented below considered in conjunction with the attached drawings and in which like reference numerals refer to similar elements.

FIG. 1 is a block diagram of a system employing iBeacon devices (hereinafter “iBeacon(s)”) in which examples of the present disclosure may operate.

FIG. 2 is a block diagram of another system in which examples of the present disclosure may operate.

FIG. 3 is a block diagram of one example of a beacon device configured to broadcast one or more “virtual beacons” (hereinafter “the attribeacon device”) in which examples of the present disclosure may operate.

FIG. 4 is a schematic block diagram of one example of an implementation of the hardware components comprising the attribeacon device of FIGS. 2 and 3.

FIG. 5 is a block diagram of one example of a system in which examples of the present disclosure may operate, when services provided by a reporting server and an attribeacon app are not available, such as for third party application developers.

FIGS. 6A and 6B are a flow diagram illustrating an example of a method of operating an attribeacon device.

FIG. 7 illustrates a diagrammatic representation of a machine in the exemplary form of a computer system within which a set of instructions, for causing the machine to perform any one or more of the methodologies discussed herein, may be executed.

It is to be understood that the attached drawings are for purposes of illustrating the concepts of the invention and may not be to scale.

### DETAILED DESCRIPTION

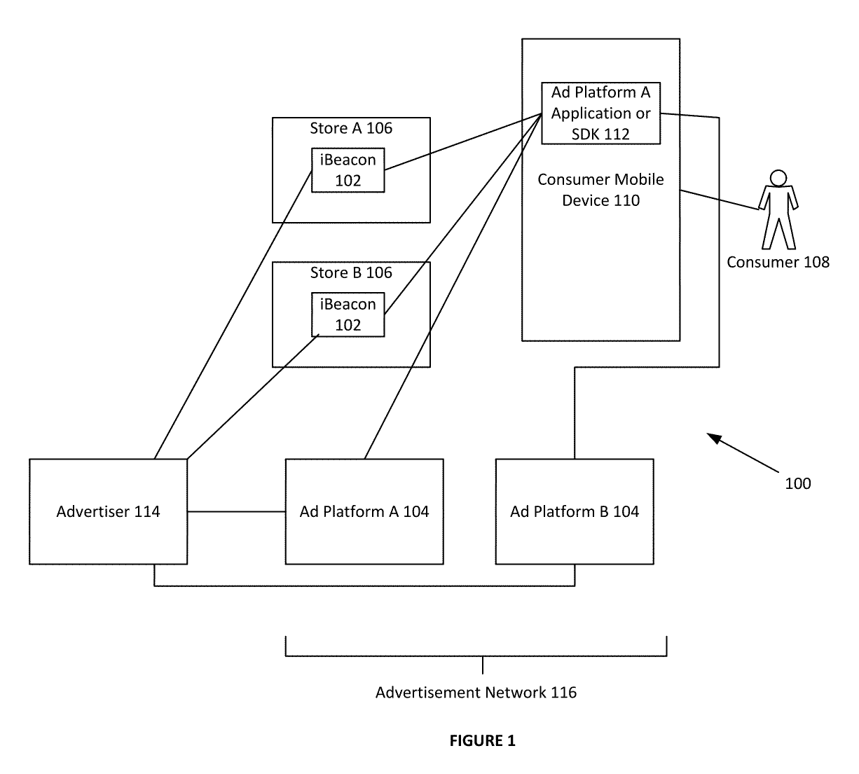

FIG. 1 is a block diagram of a system 100 employing iBeacon devices 102 (hereinafter “iBeacon(s) 102”) in which examples of the present disclosure may operate. In one example, an advertisement platform 104 (hereinafter “ad platform(s) 104”) may be configured to communicate wirelessly with one or more iBeacons 102 in physical locations (e.g., the stores 106) that a consumer 108 may visit in response to the consumer 108 viewing an advertisement on a mobile device 110. An application or software development kit (SDK) 112 (hereinafter the “app(s) 112”) on the mobile device 110 where the advertisement was displayed (e.g., part of complete platform such as Facebook or Twitter, or a third-party app with an advertisement SDK installed) registers with the ad platform 104 to be notified when the iBeacon 102 comes within range. When the app 112 on the mobile device 110 is registered with the ad platform 104 and the consumer 108 enters the physical location of a store 106, the app 112 is awakened and transmits a notification back to an advertisement network 116 that the consumer 108 with a certain IDFA (or platform-specific ID, such as a Twitter handle or a Facebook ID) is in that store 106. As used herein, an IDFA refers to an Identifier for Advertisers, which is a temporary device identifier used by the Apple set of handheld devices. An IDFA provides device identification while providing end users with the ability to limit the device/consumer information accessed by an advertiser platform 114 (hereinafter “advertiser(s) 114”) or by the apps 112.

An iBeacon 102 may broadcast a three-part identifier that may be programmed into the iBeacon 102 before it is deployed. The identifier may comprise: (1) a proximity UUID (universally unique identifier), which is a 128-bit value that uniquely identifies one or more iBeacons 102 as being of a certain type or from a certain organization; (2) a major value (identifier or ID), which is a 16-bit unsigned integer that is used to differentiate iBeacons 102 that have the same proximity UUID; and (3) a minor value (identifier or ID), which is a 16-bit unsigned integer that is used to differentiate iBeacons 102 that have the same proximity UUID and major value.

When an app 112 registers with an ad platform 104 to listen for iBeacons 102, the app 112 may supply the proximity UUID of a desired iBeacon 102. If the app 112 has supplied a proximity UUID, the app 112 on the mobile device 110 “awakens” and may perform one or more tasks whenever the mobile device 110 is in the proximity of an iBeacon 102 with the UUID. As used herein, the term “awaken(s)(ed)” refers to an application that may be running in the background that is activated by a processor in the iBeacon 102 in response to receiving a notification of an event. If an application is currently not running (e.g., terminated due to a memory issue), the application may be launched in the background, and the notification may be delivered. If the application is already in the background, the notification may be delivered to the application directly. In order to be “awakened”, the application may register with the processor in the iBeacon 102 to enable “awakening.”

The app 112 on the mobile device 110 may request to be awakened by the iBeacon 102 when the iBeacon 102 has a specific major value. In another example, the app 112 on the mobile device 110 may request to be awakened by the iBeacon 102 when the app 112 on the mobile device 110 is in the proximity of an iBeacon 102 with a specified UUID, a specific major value, and a specific minor value. When a mobile device 110 is in the range of the iBeacon 102, the mobile device 110 may be awakened by the iBeacon 102, and the mobile device 110 may be provided by the iBeacon 102 with the UUID, the major value, and the minor value of the iBeacon 102.

In the example, an advertisement network 116 comprising one or more ad platforms 104 may have one hundred (100) customers (e.g., the advertisers 114) that desire tracking. Ten (10) of the advertisers 114 may have one hundred (100) locations, and the remaining ninety (90) advertisers 114 may have one (1) location each. The one hundred (100) advertisers 114 purchase a total of 1,090 iBeacons 102. All of the iBeacons 102 may be assigned a specific UUID, e.g., CB4B5495-5E00-4CA8-85B8-E75803261C51. For the major value, a specific advertiser 114 may employ a specific customer number, e.g., from 1-100. For the minor value, a specific advertiser 114 may employ a specific location number. For customers 1-10, there are 100 iBeacons 102, each with minor values 1-100. For the remaining customers, there is a single iBeacon 102 with a minor value of 1.

The advertisement network 116 may distribute the iBeacons 102 to the advertisers 114 and may inform the advertisers 114 to place the iBeacons 102 in the stores 106 of the advertisers 114. For the 10 large advertisers 114, the advertisement network 116 may inform the 10 large advertisers 114 to place one iBeacon 102 in each store 106. The 90 small advertisers 114 place a single iBeacon 102 in one store 106 each.

In an example, the advertisement network 116 may update its app 112 to awaken its mobile device 110 any time the mobile device 110 is in the range of an iBeacon 102 with UUID CB4B5495-5E00-4CA8-85B8-E75803261C51. In response, the app 112 may display an advertisement, but whenever the mobile device 110 and its app 112 are awakened by an iBeacon 102, the app 112 may cause the mobile device 110 to transmit to one or more ad platforms 104 of the advertisement network 116 the major and minor ID of the iBeacon 102 that it is near along with the IDFA of a consumer 108. The advertisement network 116 now knows which IDFAs visited certain advertiser stores 106 and, for the big advertisers 114, which of the stores 106 the consumers 106 visited.

When an advertiser 114 of the advertisement network 116 logs in to the advertisement network web site, the advertiser 114 may see, along with their advertising impressions and clicks, how many of the consumers 108 who viewed the advertisements were present in one of the stores 106 associated with the advertisers 114 within some period of time after viewing an advertisement. For the big advertisers 114, they can view the number 1-100 of the store 106 that the consumer 108 visited.

In the example of FIG. 1, there may be significant challenges facing the advertisement network 116 and its advertisers 114. The advertisement network 116 may need to source, program, and track a large number of iBeacons 102. This is not something the advertisement network 116 may be accustomed to perform. The advertisement network 116 may need to hire a large staff for these tasks, resulting in a significant lead time. Once the advertisement network 116 has programmed the iBeacons 102 and is ready to distribute the iBeacons 102 to the advertiser 114 of the advertisement network 116, the path to placing the iBeacon 102 in the hands of installation personnel to install the iBeacons 102 correctly at the right locations of stores 106 may be complicated and lengthy.

Significantly, there may be no fool proof way to know whether a given iBeacon 102 is installed the right location of a store 106 and whether the iBeacon 102 remains in the store 106. If no transmissions are received by the advertisement network 116, if the iBeacons 102 start and stop, or if the iBeacons 102 function intermittently, the advertisement network 116 may not know whether it is because the iBeacons 102 are not in the locations of the stores 106, are being moved around, are low on batteries, or whether intermittent signals are actual patterns of traffic.

For the large, 100-location advertisers 114, the minor value may be, for example, 1-100, which is not very meaningful. The advertisers 114 may be asked to provide the locations of the 106 in advance and then the advertisement network 116 may assign minor values to the stores 106. The advertisers 114 may enter locations of the stores 106 into the ad platform 104 after the fact. Perhaps the ad platform 104 may never know which store 106 each iBeacon 102 is located. All of these scenarios are tedious and error-prone.

Over time, there may be many iBeacons 102 with the UUID of CB4B5495-5E00-4CA8-85B8-E75803261C51. Some of the iBeacons 102 may be associated with active advertisers 114 and these iBeacons 102 may be located in stores 106 designated by the advertisement network 116, but other iBeacons 102 may be associated with advertisers 114 that are no longer working with the advertisement network 116. Other iBeacons 102 may be located in boxes or located in the back of cars. The app 112 may be awakened for all of the iBeacons 102, which at best is confusing, and at worst drains batteries and may induce the consumers 108 to complain or uninstall the app 112.

With respect to conquesting, there may be a concern that an iBeacon 102 in a store 106 may be co-opted by competitors showing advertisements based on the proximity of other iBeacons 102. As used herein, conquesting refers to a means of deploying an advertisement for one's products or services adjacent to editorial content relating to a competitor or the competitors' products. Since the iBeacons 102 have a fixed and well-known ID, other apps may listen for the well-known ID.

Further complications may result when there are multiple ad platforms 104 and advertisement networks 112, because even if advertisers 114 are willing to perform installation and tracking of iBeacons 102 for one or maybe two advertisement networks 112, it is unlikely that the advertisers 114 may install iBeacons 102 for more than one advertisement network 116. Further, even if the advertisers 114 did install a number of iBeacons 102 at each location of a store 106, the problem of keeping track of the iBeacons 102 and having the iBeacons 102 dispersed in many places grows significantly when there are many iBeacons 102.

One possible solution to these deficiencies may be, rather than the app 112 of the advertisement network 116 listening for its own iBeacons 102, the advertisers 114 may place their own iBeacons 102 in each location of its stores 106. The advertiser 114 may then tell each advertisement network 116 the UUID, major, and minor numbers of the iBeacons 102 in the physical locations 208 associated with the entity 202 (perhaps aided by some third-party registry). The app 112 then adds this UUID to a listening list. A problem with this possible solution is that an app 112 may be permitted only to listen to up to 20 UUIDs. Since the advertisement network 116 may have more than 20 advertisers, the advertisement network 116 may not be able to listen to all of the iBeacons 102. However, an advantage of ranging the iBeacons 102 is to permit the apps 112 to awaken when they have something relevant to perform. If every app 112 is listening for many UUIDs, then every app 112 may be awakened constantly to attempt to communicate with the advertisement network 116. Accordingly, the mobile device 110 may run very slowly and/or quickly run out of battery charge. Furthermore, if the advertiser 114 is providing its own beacon IDs, all of the problems with making sure that the iBeacons 102 are in the right place and are working are compounded. The advertisement network 116 may have no idea what kind of iBeacons 102 with which they may be communicating or where the iBeacons 102 are located. There may be very little that the advertisement network 116 can do to mitigate these problems.

The clue solving these complications presents itself when considering, rather than trying to “work around” the limit of 20 UUIDs, why that limit makes sense. The limit makes sense because an app 112 should register to be awakened when it has something relevant to perform. The typical scenario presented for an iBeacon 102 is that, for example, a major league baseball (MLB) app (e.g., the app 112) performs actions when a consumer 108 is located in a stadium or the Apple app performs actions when a consumer 108 is near a certain product in the Apple store. The presence of an iBeacon 102 with the MLB UUID or the Apple Store UUID generally means that the app (e.g., the app 112) does have something relevant to perform.

One further complication that may arise is that the iBeacons 102 relevant to an app 112 for advertising attribution may be changed frequently. The iBeacons 102 that a single advertisement network 116 are all relevant to the apps 112 of the advertisement network 116 when the iBeacons 102 are first distributed, but even the iBeacons 102 do not remain relevant to the advertisement network 116 forever, because the advertisers 114 come and go. The iBeacons 102 that are configured by the advertiser 114 may not be, at first, even relevant to the advertisement network 116. By the time the iBeacons 102 become relevant, their UUID's are already fixed.

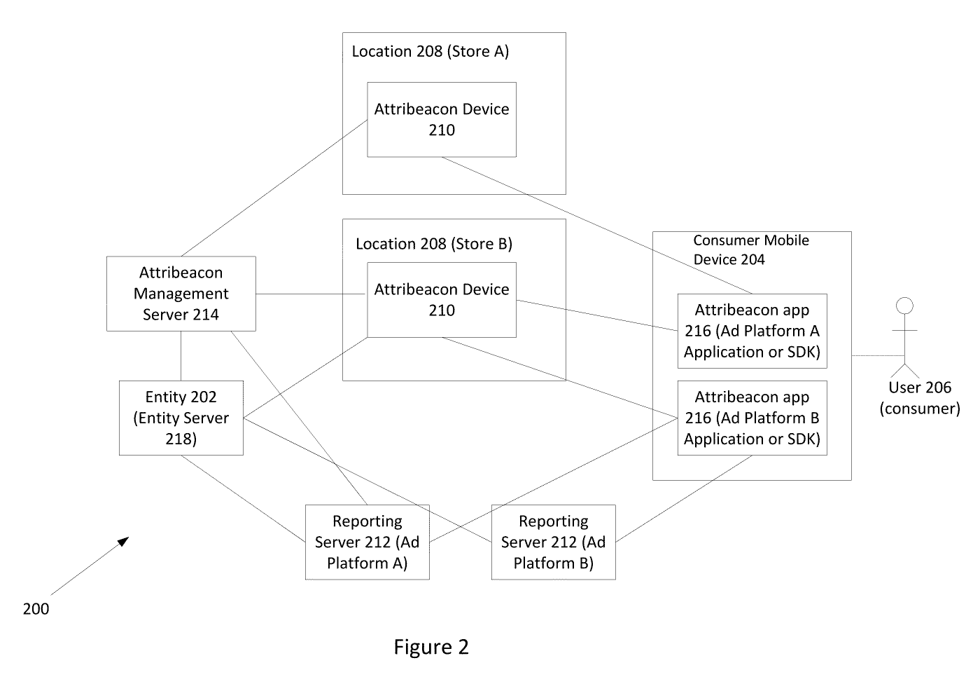

FIG. 2 is a block diagram of one example of a system 200 in which examples of the present disclosure may operate. In one non-limiting scenario, an entity 202 (e.g., a computer platform associated with an advertiser, an organization, a government agency, etc.) may wish to transmit a notification (e.g., an advertisement associated with an advertiser) to mobile device(s) 204 in possession of user(s) 206 (e.g., consumer(s)) that target the user(s) 206 to visit physical location(s) 208 (e.g., stores or portions of a store) associated with the entity 202 (e.g., the advertiser). After transmitting the notification, the entity 202 (e.g., the advertiser) may wish to see how many users 206 (e.g., consumers) that received the notification (e.g., the advertisement) subsequently visited the physical location(s) 208 (e.g., stores—perhaps for testing different advertisements, analyzing which of the users 206 by demographics or past behavior were most likely to respond, etc., which is routinely performed in online advertising).

With respect to installation of beacon devices 210 (hereinafter “attribeacon devices 210”), the entity 202 (e.g., the advertiser) may employ one or more computer servers 212 that manage identification information and location information related to the entity 202 (e.g., one or more advertising platforms; hereinafter “the reporting server(s) 212”). The entity 202 may obtain an attribeacon device 210 for each of their physical location(s) 208 and an account on a server 214 that manages the attribeacon device 210 (hereinafter “the attribeacon management server 214”). Each of the attribeacon devices 210 may be allocated a unique identifier before they are shipped. The entity 202 may install an attribeacon device 210 in each of their physical locations 208.

As described above, in an example, when an attribeacon device 210 is initially plugged into AC power of a physical location 208 associated with an entity 202, the attribeacon device 210 boots into a “setup” mode. An installer may employ a configuration mobile app associated with attribeacon management server 214 to configure the attribeacon device 210. The setup process would minimally comprise: (1) the installer logging into the configuration mobile app (i.e., the attribeacon management server 214), using his/her credentials; (2) the installer obtaining the store name and a list of the names of the store locations (e.g., Macy's, 34^{th} Street, i.e., the physical locations 208) associated with the entity 202; (3) the installer selecting a location (located in the attribeacon management server 214) for the attribeacon device 210 from the list; (4) the attribeacon management server 214 creating an association between the attribeacon device 210 and the selected location on the server side; and (5) the attribeacon management server 214 programming the attribeacon device 210 with the new location. Accordingly, the attribeacon management server 214 now has a record of which attribeacon device 210 (identified by its pre-allocated unique identifier) is in which of the physical locations 208 associated with the entity 202. Note, programming the location of the attribeacon device 210 may be somewhat absolute location agnostic. Rather than programming exact physical locations (e.g., latitude and longitude), the name of the store location is employed (e.g., 34^{th} street). Accordingly, the system 200 would work even for a mobile location, e.g., a food truck or popup store.

In another example, the entity 202 (e.g., an advertiser) may have already loaded their list of locations, e.g., the names/addresses/phone numbers of their stores into the dashboard of the attribeacon management server 214, and based on the addresses, the attribeacon management server 214 may correlate these addresses to corresponding latitude/longitude coordinates. Accordingly, the attribeacon management server 214 may have access to the list of locations, and by comparing geocoordinates, the attribeacon management server 214 may determine which attribeacon device 210 is residing in which location.

In an example, the entity 202 (e.g., the advertiser) may select the reporting server(s) 212 from which it wishes to transmit notifications (e.g., run advertisements associated with an advertisement campaign (without examples of the present disclosure, an entity 202 would need to select the reporting server(s) 212 in advance and obtain iBeacons 102 from the reporting server(s) 212). For each of the reporting server(s) 212: (1) An attribeacon device 210 in each of the physical locations 208 (e.g., stores) may be configured to transmit an identifier that uniquely identifies the reporting server 212. In one example, the identifier that uniquely identifies the reporting server 212 may be a proximity UUID, selected by the reporting server 212, that a mobile app/SDK 216 (hereinafter the “attribeacon app 216”) running on the mobile device(s) 204 in possession of user(s) 206 and associated with the reporting server 212 for which it is configured to listen. The attribeacon device 210 in each of the physical locations 208 associated with the entity 202 may be configured to transmit an identifier that uniquely identifies an individual entity 202. In one example, the identifier that uniquely identifies an individual entity 202 may be a major value (identifier or ID), selected by the reporting server 212, that identifies the entity 202 according to a scheme selected by the reporting server 212. The attribeacon devices 210 in each of the physical locations 208 associated with the entity 202 may be configured to transmit location information related to the attribeacon device 210. In one example, the location information may be a physical location 208 of the attribeacon device 210 or a portion of the physical location 208 of the attribeacon device 210. In one example, the location information may be a minor value (identifier or ID), selected by the attribeacon management server 214 to correspond to a physical location 208 in which the attribeacon device 210 has been placed.

In another example, the reporting server 212 may obtain a list of physical locations 208 associated with the entity 202 using the attribeacon management server 214. The attribeacon management server 214 may assign minor values to attribeacon device 210 according to its own scheme.

In another example, the reporting server 212 (via the advertiser) may select a combination of a major value (identifier or ID) and a minor value (identifier or ID) to identify the location information related to the attribeacon device 210 (e.g., a store location).

In another example, instead or receiving the actual UUID/major/minor values from an authorized reporting server 212 (e.g., ad-platform/network), the beacon management server 214 may receive a beacon configuration scheme (i.e., how UUID/major/minor values should be assigned to locations) from the reporting server 212 (e.g., ad-platform/network). The beacon management server 214 then creates the UUID/major/minor values, which conforms to the beacon configuration scheme, programs an attribeacon device 210 with the appropriate UUID/major/minor value for the reporting server 212 (e.g., ad-platform/network), and transmits the list of locations and UUID/major/minor values back to the reporting server 212 (e.g., ad-platform/network).

In an example, the entity 202 may perform an authorization sequence involving the attribeacon management server 214 and the reporting server 212, in which the entity 202 may authorize the reporting server 212 to perform operations in the account of entity 202 within the attribeacon management server 214. Those skilled in the art will realize that any suitable authorization sequence may be employed. For example, the authorization sequence may be a standard authorization procedure in which the entity 202 enters credentials, and verification of the credentials results in reporting server 212 receiving a token that enables the reporting server 212 to act on behalf of the entity 202 in the attribeacon management server 214.

The entity 202 may configure a notification scheme (e.g., an advertisement campaign) in the reporting server 212, but the entity 202 may indicate that they wish to have the effectiveness of the notification scheme tracked via the attribeacon device 210. As used herein, an advertisement campaign refers to the process of buying an advertisement, defining how long the advertisement should run, who the advertisement should target, what keywords would trigger the advertisement, where the advertisement should take consumers to, etc.

As part of completing a configuration of the notification scheme, the reporting server 212 selects a major value for broadcast by the attribeacon devices 210 from the physical locations 208 associated with the entity 202 to identify the entity 202 to the reporting server 212.

In a further example, to restrict reporting to a subset of all of the stores of an advertiser having attribeacon devices 210 in all of its stores, the entity 202 (e.g., the advertiser) may select a specific geo-region for the advertisement campaign (e.g., target the ads to males, ages 25-30, in New York City). The reporting server 212 (e.g., an advertisement platform) may pass this information back to the attribeacon management server 214, which then configures only the attribeacon devices 210 that are located in New York City.

In an example, the reporting server 212 may be configured to contact the attribeacon management server 214 and to provide the attribeacon management server 214 with instructions to, for a selected entity 202: (1) broadcast proximity UUID x (one of the standard proximity UUID's used by the reporting server 212); broadcast a major value selected by the reporting server 212 to identify the selected entity 202; and (3) broadcast a minor value as determined by the attribeacon management server 214 to identify the particular physical location 208 (e.g., a store). In another example, the provided instructions may include a list of given minor IDs to broadcast for each corresponding physical location 208 (e.g., store), as selected by the reporting server 212.

In an example, a server 214 (e.g., a beacon management server 214) may be configured to (a) keep a record of which attribeacon devices 210 are located in which locations, (b) authorizes ad platforms/networks (e.g., reporting servers 212) access to the attribeacon devices 210, and (c) facilitates the programming of the attribeacon devices 210.

In one example, the beacon management server 214 may be configured to receive location information of all of the attribeacon devices 210 (i.e., which attribeacons 210 are associated with which physical stores, or regions within stores). The beacon management server 214 also receives requests (from the entity 202, e.g., advertiers) to authorize one or more reporting servers 212 (e.g., ad-platforms/networks) access to the attribeacon devices 210. The beacon management server 214 transmits the authorized ad-platforms/networks the list of locations, and receives (from the reporting servers 212, e.g., ad-platforms/networks) the list of UUID/major/minor values for the corresponding list of locations. The beacon management server 214 configures an attribeacon device 210 with the appropriate UUID/major/minor values that identify the location and reporting servers 212 (e.g., ad-platforms/networks).

In another example, instead of receiving the actual UUID/major/minor values from an authorized reporting server 212 (e.g., ad-platform/network), the beacon management server 214 may receive a beacon configuration scheme (i.e., how UUID/major/minor values should be assigned to locations) from the reporting server 212 (e.g., ad-platform/network). The beacon management server 214 then creates the UUID/major/minor values, which conforms to the beacon configuration scheme programs an attribeacon device 210 with the appropriate UUID/major/minor value for the reporting server 212 (e.g., ad-platform/network), and transmits the list of locations and UUID/major/minor values back to the reporting server 212 (e.g., ad-platform/network).

In one example, the beacon management server 214 receives instructions to de-authorize a reporting server 212 (e.g., ad-platform/network). The beacon management server 214 transmits instructions to associated attribeacon devices 210 (which had been broadcasting the reporting server's 212 (e.g., ad-platform/network's) UUID/major/minor values) to stop broadcasting the reporting server's 212 (e.g., ad-platform/network's) identifier. Additionally, the beacon management server 214 communicates to the reporting server 212 (e.g., ad-platform/network) that the reporting server 212 (e.g., ad-platform/network) no longer has access to the associated attribeacon devices 210.

In one example, the beacon management server 214 receives instruction to authorize a new reporting server 212 (e.g., ad-platform/network). The beacon management server 214 transmits the list of locations to the reporting server 212 (e.g., ad-platform/network), receives from the reporting server 212 (e.g., ad-platform/network) either the list of identifiers or configuration schemes to create the identifiers. The beacon management server 214 transmits add instruction (with the reporting server's 212 (e.g., ad-platform/network's) identification values) to all active attribeacon devices 210.

In one example, the beacon management server 214 retains open communications with all active attribeacon devices 210. The beacon management server 214 monitors whether the attribeacon devices 210 are behaving appropriately and reinistates those that are not behaving appropriately.

In another example, the attribeacon devices 210 periodically pings the beacon management server 214 (as a way to indicate that the attribeacon devices 210 is still behaving appropriately). The beacon management server 214 may reinitiate those attribeacon devices 210 that have not pinged the server in an extended amount of time.

In one example, the beacon management server 214 receives activation instruction for a new attribeacon device 210 (and its location information). The beacon management server 214 transmits the location information to all currently authorized reporting servers 212 (e.g., ad-platform/networks), obtains the UUID/major/minor values, and programs the newly activated attribeacon device 210. In one example, the beacon management server 214 receives instruction to deactivate a set of existing attribeacon devices 210. The beacon management server 214 communicates the deactivation requests to all currently authorized reporting servers 212 (e.g., ad-platform/networks) and removes the UUID/major/minor values from their memories.

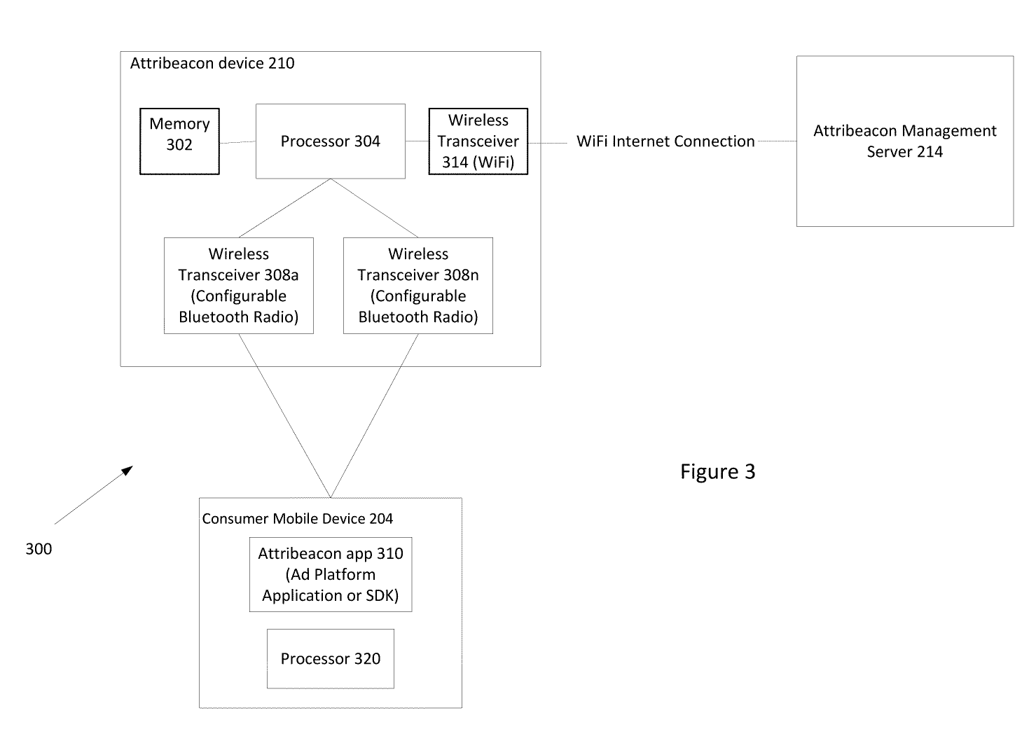

FIG. 3 is a block diagram 300 of one example of an attribeacon device 210 configured to broadcast one or more “virtual beacons” in which examples of the present disclosure may operate. In one example, the attribeacon device 210 may comprise a memory 302 and a computer processor 304 (hereinafter “the processor 304”) couple to and having use of the memory 302. The attribeacon device 210 may further comprise one or more wireless transceivers 308a-308n communicatively coupled to the processor 304 and configured to broadcast one or more “virtual beacons” to an application 310 or a software development kit (SDK) 310 (hereinafter, “the attribeacon app 310”) configured to run on the mobile device(s) 210 associated with user(s) 206 (e.g., the consumer(s) 206). In one example, the one or more wireless transceivers 308a-308n are one or more Bluetooth wireless transceivers. The attribeacon device 210 may further comprise a wireless transceiver 314 communicatively coupled to the processor 304 and configured to communicate with the attribeacon management server 214. In one example, the wireless transceiver 314 may be a WiFi wireless transceiver. In one example, the attribeacon device 210 may be powered by alternating current from a wall socket. Accordingly, the attribeacon device 210 may be powered by an AC-to-DC power supply 216.

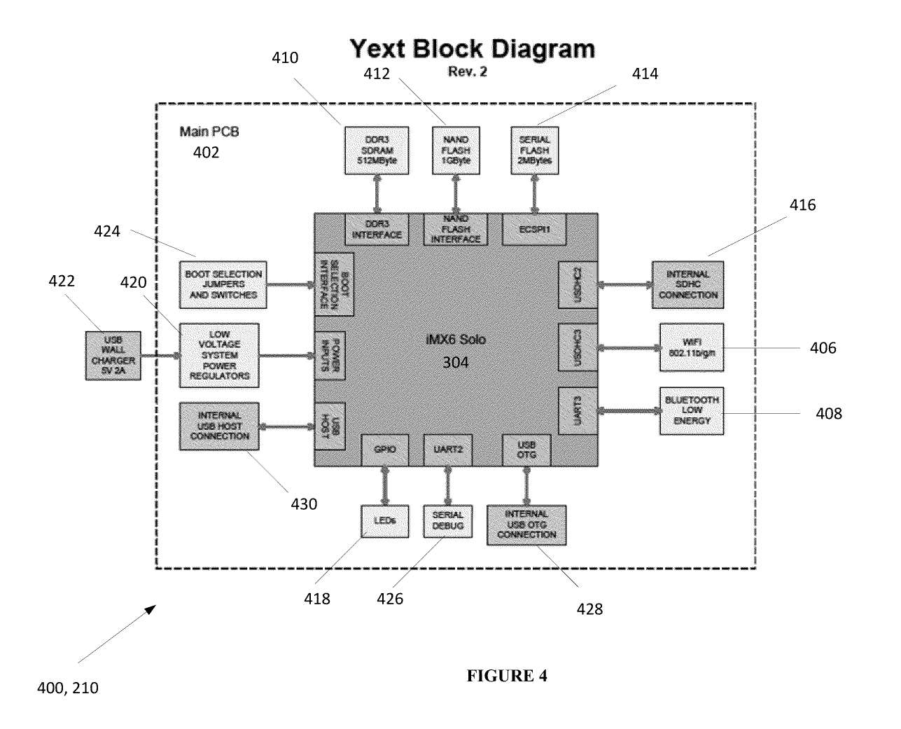

FIG. 4 is a schematic block diagram 400 of one example of an implementation of the hardware components comprising the attribeacon device 210 of FIGS. 2 and 3. A main printed circuit board (PCB) 402 includes the processor 304 having a plurality of interfaces coupled to a plurality of devices located on the PCB 402. The processor 304 may be, for example, an iMX6 Solo single core processor manufactured by Freelance, and configured to run the Linux operating system. It should be noted other brand and/or types of processors may be employed. The processor 304 may be coupled to a WiFi module 406 that functions as the wireless transceiver 314. The WiFi module 406 may implement, for example, the IEEE 802.11 b/g/n standards for wireless transmission/reception. The processor 304 may be coupled to a Bluetooth Low Energy radio 408 supporting the Bluetooth 4.0 standard that functions as the one or more wireless transceivers 308a-308n. As used herein, Bluetooth Low Energy (a.k.a. Bluetooth smart) was first implemented by Nokia in about 2006, and then merged into the Bluetooth 4.0 standard in 2010. It is not backwards compatible with the previous generation bluetooth (a.k.a. Bluetooth classic). However, both Bluetooth Low Energy (BLE) and Bluetooth Classic use the same 2.4 GHz spectrum, which permits a single device to operate in both modes. i.e., a single bluetooth radio can be configured to transmit classic or BLE signals. The Bluetooth 4.0 standard permits the implementation of BLE and/or Classic and hence, dual-mode.

The processor 304 is further coupled to 512 MByte DDR3 memory module 410 configured to provide volatile free memory for the processor 304; a 1 GByte NAND flash memory module 412 configured to provide non-volatile memory for the processor 304 that can be employed to store the operating system (e.g. Linux) and applications; and a 2 MByte serial flash module 414 configured to function as further non-volatile memory that stores basic configuration information. An internal SDHD card slot 416 may be provided to permit reception of an external secure digital SD memory card (not shown) for providing a boot load image for the processor 304. The processor 304 may boot either from the secure digital SD memory card or from the serial flash module 414. The DDR3 memory module 410, the NAND flash memory module 412, the serial flash module 414, and optionally the external secure digital SD memory card (not shown) may collectively function as the memory 302.

During initial power-up of the attribeacon device 210, the serial flash module 414 may contain the instruction to load a boot loader, which contains further instructions to load an operating system (OS, e.g., Linux) and an embedded application (and various device drivers) to the processor 304 and initiates the attribeacon device 210. After the attribeacon device 210 is properly configured, the attribeacon device 210 behavior is described as outlined in FIGS. 2, 3, and 6.

Remaining modules may include: a plurality of indicator LEDs 418; a low voltage system power regulator 420 (overvoltage/current protection) coupled to the processor 304 and to an external wall charger 422 functioning as the AC-to-DC power supply 216; boot selection jumper and switches 424 to permit a hardware developer to switch the processor 304 to different modes of operation; a serial debug port 426; internal USB OTG connectors 428, 430 for receiving a USB host that runs BSP (board support package) software that is needed to support running the OS on the attribeacon device 210 for application loading and debugging purposes.

Returning to FIG. 3, in an example, the processor 304 may be configured to retrieve from the memory 302 a list of entries of identification information. In one example, each entry in the list of identification information may comprise a field for storing an identifier (e.g., a proximity universal unique identifier (UUID)) of a server that manages an individual entity in the list (e.g., the reporting server 212, e.g., to manage an advertisement campaign for an advertiser on an advertisement platform server). Each entry in the list of identification information may further comprise a field for storing an identifier (e.g., a major value or major identifier) of an entity 202 (e.g., an advertiser, a business, an organization, a government agency, etc.). Each entry in the list of identification information may further comprise a field for storing an identifier (e.g., a minor value or minor identifier) that identifies location information related to the attribeacon device 210 (e.g., the physical location of the attribeacon device 210, e.g., in latitude/longitude coordinates).

The location information may be, for example, a physical location 208 of the attribeacon device 210 (e.g., the physical location of a store) or a portion of the physical location of the attribeacon device 210 (e.g., a specific department in the store).

In another example, the major value and minor value may be combined into a single identifier that identifies entity-location pair combinations.

The processor 304 may be further configured to select one or more of the wireless transceivers 308a-308n. The processor 304 may be further configured to divide the list of identification information related to the plurality of entities into one or more sub-lists of identification information related to the plurality of entities, one sub-list corresponding to a selected wireless transceiver (e.g., 308a) of the one or more wireless transceivers 308a-308n. The processor 304 may be further configured to instruct the selected wireless selected wireless transceiver (e.g., 308a) to repeatedly cycle through broadcasting each of entries in a designated sub-list of the list of identification information related to the plurality of entities in successive first time intervals. The length of the first time intervals may be selected by the processor 304 such that the transmitted entries may be received and processed by the mobile device(s) 204 associated with user(s) 206 in a second time interval that corresponds to a minimum required beacon broadcast interval. In an example, the first-time interval is longer than the minimum required beacon broadcast interval (second time interval), such that the transmitted entries may be received and processed by nearby mobile device(s) 204 as simultaneous and independent beacon signals that are associated with different attribeacon devices 210. In another example, the minimum required beacon broadcast interval may be equal to or greater than a sum of the successive first time intervals in the designated sub-list of entries. Thus, the broadcast sub-list list of entries may be received and be processed by the mobile device(s) 204 associated with user(s) 206 as a sub-list of “virtual beacons.” To the mobile device(s) 204, it is as if the attribeacon device 210 were broadcasting a plurality of beacons (e.g., “virtual beacons”) at the same time.

In an example, the attribeacon device 210 may be programmed by the attribeacon management server 214 over a wireless network using the wireless transceiver 314. The wireless transceiver 314 may be configured to receive from the attribeacon management server 214 the list of entries of identification information corresponding to the plurality of entities (e.g., wherein each entry in the list comprises a field identifying a reporting server 212, a field identifying an entity 202, and a field identifying a location of the attribeacon device 210). The wireless transceiver 314 may be configured to transmit to the processor 304 the list of entries of identification information. The processor 304 may be configured to store in the memory 302 the list of entries of identification information to be broadcast as virtual beacons.

In an example, the attribeacon device 210 may be further programmed by the attribeacon management server 214 to add, delete, or change the number of values of the identification information. The wireless transceiver 214 may be configured to receive one or more additional sets of identification information related to one or more corresponding additional entities to be added to or deleted from the list, wherein each set has one or more entries. The wireless transceiver 214 may be configured to transmit to the processor 304 the one or more additional sets of identification information. The processor 304 may then add to or delete from the list the one or more additional sets of identification information to produce an updated list. The processor 304 may be configured to repeat the process of transmitting virtual beacon for the updated list.

In an example, the processor 304 may be further configured to select one or more of the wireless transceivers 308a-308n. The processor 304 may be further configured to instruct the selected one or more wireless transceivers 308a-308n to repeatedly cycle through broadcasting each of the entries in a designated sub-list of the list of identification information related to the plurality of entities in successive first time intervals. The length of the first time intervals may be selected by the processor 304 such that the transmitted entries may be received and processed by the mobile device(s) 204 associated with user(s) 206 in a second time interval, that is, a minimum required beacon broadcast interval. In an example, the first-time interval is longer than the minimum required beacon broadcast interval (second time interval), such that the transmitted entries may be received and processed by nearby mobile device(s) 204 as simultaneous and independent beacon signals that are associated with different beacon devices 210. In another example, the minimum required beacon broadcast interval may be equal to or greater than a sum of the successive first time intervals in the designated sub-list of entries. Thus, the broadcast updated list of entries are to be received and to be processed by the mobile device(s) 204 associated with user(s) 206 as an updated list of “virtual beacons.”

In an example, when an attribeacon device 210 is initially plugged in to AC power of a physical location 208 associated with an entity 202 (e.g., a store of an advertiser. See FIG. 4), the attribeacon device 210 boots into a “setup” mode. An installer would employ a configuration mobile app associated with attribeacon management server 214 to configure the attribeacon device 210. The setup process would minimally comprise (1) the installer logging in to the configuration mobile app (i.e., the attribeacon management server 214), using his/her credentials; (2) the installer obtaining a list of all of the physical locations 208 associated with the entity 202 along with data concerning the geographic locations (latitude and longitude) of the physical locations 208 associated with the entity 202 of FIG. 4; (3) the installer selecting a location (located in the attribeacon management server 214) for the attribeacon device 210 from the list; (4) the attribeacon management server 214 creating and association between the attribeacon device 210 and the selected location on the server side; and, (5) the attribeacon management server 214 programming the attribeacon device 210 with the new location.

Accordingly, the attribeacon management server 214 may program/re-program the attribeacon device 210 with (a) a list of entries of identification information corresponding to the plurality of entities, (b) the attribeacon device 210 may broadcast multiple entries of identification information related to the multiple entities using one or more one or more wireless transceivers 308a-308n and, (c) each of the one or more wireless transceivers 308a-308n may broadcast in a rotating fashion by repeatedly rotating through a selected set of entries of identification information associated with the attribeacon device 210.

In an example, the attribeacon management server 214 may contact the attribeacon device 210 present in each of the physical locations 208 associated with the entity 202. The attribeacon management server 214 may configure the attribeacon app 310 running on the attribeacon device 210 to include in a list of “virtual beacons” of the attribeacon device 210 a virtual beacon with the following configuration: (1) a proximity UUID as supplied by the reporting server 212; (2) a major ID as supplied by the reporting server 212; and (3) a minor ID as selected by the attribeacon management server 214 to identify a physical location 208 associated with the entity 202 (e.g. a store). In another example, an identifier (ID) may be provided by the reporting server 212 for the physical location 208 associated with the entity 202 in which the attribeacon device 210 is located.

The attribeacon app 310 in the attribeacon device 210 may instruct the attribeacon device 210 to routinely transmit broadcasts that advertise the presence of the attribeacon device 210 with the aforementioned identifiers. The attribeacon device 210 carries out the instructions using one or both of the following techniques: (1) multiple radios: the attribeacon app 310 informs one wireless transceiver (e.g., 308a, e.g., a Bluetooth radio) to broadcast one of the (proximity UUID, major ID, minor ID) combinations requested, and then informs another wireless transceiver (e.g., 308b, e.g., a Bluetooth radio) to broadcast the next (proximity UUID, major ID, minor ID) combination, etc.; (2) radio rotation: the attribeacon app 310 keeps a list of each (proximity UUID, major ID, minor ID) combination to broadcast. The attribeacon app 310 instructs a wireless transceiver (e.g., 308a, e.g., Bluetooth radio) to transmit a first combination of the (proximity UUID, major ID, minor ID) combinations, then, after a short interval, the attribeacon app 310 instructs the same wireless transceiver (e.g., 308a, e.g., the same Bluetooth radio) to broadcast a second combination of the (proximity UUID, major ID, minor ID) combinations, and so on, through all of the ID combinations that the attribeacon app 310 is configured to broadcast. In the latter example, because the broadcasts are periodic, the mobile device(s) 204 in possession of user(s) 206 (e.g., consumer(s)) in a physical location 208 associated with the entity 202 is to receive and to process, e.g., perceives, multiple different virtual beacons/devices, each with a different combination of IDs, rather than just one.

By employing one or both of these techniques, the attribeacon device 210 may behave as if it were many devices even though it is only one. If, for example, the attribeacon device 210 comprises two wireless transceivers (e.g., 308a, 308b) that are each configured to rotate through five ID combinations, the attribeacon device 210 may be received and processed by in-range mobile devices 204 as if there were ten attribeacon devices 210. In another example, one of the two example transmission techniques may be used.

The user 206 of the mobile device 204 may be running the attribeacon app 310 or a corresponding web site on their mobile device 204, which provides the attribeacon app 310 with an opportunity to display an advertisement. The attribeacon app 310 running on the mobile device 204 of the user 206 of the mobile device 204 may be configured to detect and process identification information related to one or more of a plurality of entities 202 broadcast by an attribeacon device 210, and to report the processed identification information to a server that manages the identification information (e.g., a reporting server 212). A processor 320 of the mobile device 204 may execute an application (e.g., the attribeacon app 310) of the mobile device 204 having an identification information (e.g., a platform-specific identifier (IDFA), e.g., a Twitter handle or a Facebook or email login identifier) that identifies the user 206 of the mobile device 204 or identifies the mobile device 206. The processor 320 may retrieve from the attribeacon app 310, the identification information that identifies the user 206 of the mobile device 204 or identifies the mobile device 204. The processor 320 may transmit to the reporting server 212, the identification information that identifies the user 206 of the mobile device 204 or identifies the mobile device 204 as an indication that the processor 320 has registered with the reporting server 212.

The attribeacon app 310 may request from the reporting server 212, a notification (e.g., an advertisement) related to the entity 202 (e.g., an advertiser). The application app 310 may instruct the processor 320 to display the notification related to the entity 202 on a display of the mobile device 204.

The application app 310 may receive from the reporting server 212, a set of identifiers to be broadcast by the attribeacon device 210. The attribeacon app 310 may register with the processor 320 the set of identifiers in a list of identifiers pertaining to identification information related to the plurality of entities 202. If the application app 310 is sleeping, when the processor 320 detects the presence of a beacon signal having one of the set of identifiers in a list of identifiers, the application app 310 is “awakened” to process the received signal. If the application app 310 is currently active, the application app 310 simply processes the received signal.

In an example, when awakened, the attribeacon app 310 may receive a first identifier (e.g., a proximity UUID) broadcast by the attribeacon device 210 that pertains to identification information related to an entity 202. The application app 310 may determine whether the first identifier is in the list of identifiers (e.g., proximity UUIDs) pertaining to identification information related to a plurality of entities 202 for which the attribeacon app 310 has registered to receive notification information related to the entity 202. If the attribeacon app 310 identifies the first identifier in the list of identifiers, then the attribeacon app 310 permits receiving one or more additional identifiers broadcast by the attribeacon device 210, the one or more additional identifiers (e.g., major ID and minor ID) associated with the first identifier and pertaining to identification information related to the entity 202. The attribeacon app 310 may transmit the first identifier and the one or more additional identifiers associated with the first identifier to the reporting server 212.

If the attribeacon app 310 does not identify the first identifier in the list of identifiers, then the attribeacon app 310 does not permit receiving the one or more additional identifiers broadcast by the attribeacon device 210. In an example, the attribeacon app 310 repeats the above steps for any remaining first-type identifiers (e.g., proximity UUIDs) broadcast by the attribeacon device 210.

In another example, the attribeacon app 310 on the mobile device 204 may request to be awakened by the attribeacon device 210 is broadcasting a specific major value. In another example, the attribeacon app 310 on the mobile device 204 may request to be awakened by the attribeacon device 210 when the attribeacon app 310 on the mobile device 204 is in the proximity of an attribeacon device 210 with a specified UUID, a specific major value, and a specific minor value. When a mobile device 204 is in the range of the attribeacon device 210, the mobile device 204 may be awakened by the iBeacon 102, and the mobile device 204 may be provided by the attribeacon device 210 with the UUID, the major value, and the minor value of the attribeacon device 210.

In an example, prior to receiving the identification information associated with the attribeacon device 210, the reporting server 212 may be configured to select the identification information associated with an attribeacon device 210 (e.g., the major ID, the minor ID, and the corresponding proximity UUID). The reporting server 212 may be configured to transmit the identification information to the attribeacon management server 214 so that the attribeacon management server 214 may program the attribeacon device 210 to broadcast the identification information.

In an example, prior to receiving the identification information associated with a attribeacon device 210 (e.g., the major ID, the minor ID, and the corresponding proximity UUID), the reporting server 212 may be configured to transmit to the attribeacon management server 214 a request for the identification information associated with the attribeacon device 210. The reporting server 212 may be configured to receive from the attribeacon management server 214 the identification information associated with the attribeacon device 210. The reporting server 212 may be configured to associate in the data store (not shown), the identification information with the physical location 208 associated with the entity 202.

In an example, the reporting server 212 may receive from an attribeacon app 310, which had been programmed to listen for the reporting server 212 (ad-platform/network)-specific identifiers, running on the mobile device 204, identification information identifying a user 206 of the mobile device 204 or the mobile device 204. The reporting server 212 may receive from the attribeacon app 310, identification information associated with an attribeacon device 210. The reporting server 212 may determine whether the beacon identification information is associated with an existing advertisement campaign that has attribeacon devices 210 assigned to the reporting server 212. The reporting server 212 decides whether the user 206 is in the list of users who have seen the advertisement that is associated with the campaign. If the identification information identifying the user 206 of the mobile device 204 or the mobile device 204 corresponds to a user or a mobile device registered to receive notification information that has seen a location-specific advertisement, then the reporting server 212 may associate in a data store (not shown) the location-specific advertisement with the entity 202 with the user 206 or the mobile device 204 registered to receive notification information. Otherwise, the reporting server 212 does not form an association in a data store (not shown).

In an example, the identification information identifying a user 206 of the mobile device 204 or the mobile device 204 may be a platform-specific identifier (IDFA). In an example, the identification information identifying a user 206 of the mobile device or the mobile device 204 may serve as a registration request by the user 206 of the mobile device 204 or the mobile device 204 to receive the notification information related to the entity 202.

In an example, the entity 202 (e.g. advertiser), in a reporting dashboard, powered by data from the reporting server 212, may view the number of people (or devices) have been served the advertisement, have seen the advertisement, and have actually visited the store locations.

As discussed hereinabove, the entity 202 may perform an authorization sequence involving the attribeacon management server 214 and the reporting server 212, in which the entity 202 may authorize the reporting server 212 to perform operations in the account of entity 202 within the attribeacon management server 214. Those skilled in the art will realize that any suitable authorization sequence may be employed. For example, the authorization sequence may be a standard authorization procedure in which the entity 202 enters credentials, and verification of the credentials results in reporting server 212 receiving a token that enables the reporting server 212 to act on behalf of the entity 202 in the attribeacon management server 214.

The entity 202 may configure a notification scheme (e.g., an advertisement campaign) in the reporting server 212, but the entity 202 may indicate that they wish to have the effectiveness of the notification scheme tracked via the attribeacon device 210. As part of completing a configuration of the notification scheme, the reporting server 212 selects a major value for broadcast by the attribeacons 210 from the physical locations 208 associated with the entity 202 to identify the entity 202 to the reporting server 212. As used herein, an advertisement campaign refers to the process of buying an advertisement, defining how long the advertisement should run, who the advertisement should target, what keywords would trigger the advertisement, where the advertisement should take consumers to, etc.

In a further example, to restrict reporting to a subset of all of the stores of an advertiser having attribeacon devices 210 in all of its stores, the entity 202 (e.g., the advertiser) may select a specific geo-region for the advertisement campaign (e.g., target the ads to males, ages 25-30, in New York City). The reporting server 212 (e.g., an advertisement platform) can pass this information back to the attribeacon management server 214, which then configures only the attribeacon devices 210 that are located in New York City.

In an example, the reporting server 212 may be configured to contact the attribeacon management server 214 and to provide the attribeacon management server 214 with instructions for a selected entity 202: (1) broadcast proximity UUID x (one of the standard proximity UUID's used by the reporting server 212); broadcast a major value selected by the reporting server 212 to identify the selected entity 202; and (3) broadcast a minor value as determined by the attribeacon management server 214 to identify the particular physical location 208 (e.g., a store). In another example, the provided instructions may include a list of given minor IDs to broadcast for each corresponding physical location 208 (e.g., store), as selected by the reporting server 212.

In an example, a reporting server 212 may be configured to report (a) those consumers 206 who have been served and seen the ads, and (b) those consumers 206 who have entered the regions monitored by beacons 210. The reporting server 212 may be configured to cross correlate (a) and (b) to determine which consumers 206 have both seen the ads and visited a location, thereby, closing a loop in the overall system 200.

In an example, the reporting server 212 may be configured to add to the data store the identification information associated with the user 206 or the mobile device 204 to a list of users who have visited the physical location 208 associated with the entity 202. In an example, the reporting server 212 may be configured to report to a server associated with the entity 202 (hereinafter, the “entity server 218”), the list of users who have visited the physical location 208 associated with the entity 202.

In an example, the reporting server 212 may be configured to extract from the list of users who have visited the physical location 208 associated with the entity 202, the number of users that have viewed the notification related to the entity 202. The reporting server 212 may be configured to report to the entity server 218, the number of users that have viewed the notification related to the entity 202.

More specifically, an entity 202 (e.g., an advertiser) may desire to see how effective their campaign has been in driving users 206 (e.g., consumers) to their physical locations 208 (e.g., stores). The entity 202 may request a report from the reporting server 212. The reporting server 212 may use its records to show: (1) how many users 206 saw the notification associated with the entity 202 (e.g., the advertiser's advertisement) on their mobile device 204; (2) among those specific users 206, how many entered one of the physical locations 208 associated with the entity 202 (e.g., advertiser's stores); and (3) how many users 206 entered which of the physical locations 208 associated with the entity 202 (e.g., advertiser's stores), as identified by the minor ID used for a physical location 208.

Analysis may be “broken out” in many useful ways as is well known to those skilled in the art. One particularly useful analysis that may be performed is to record where the users 206 were located when they viewed the notification (e.g., advertisement) and how the distance from a physical location 208 (e.g., store) is related to the likelihood that the users 206 then visit the physical location 208 (e.g., store).

When a notification period (e.g., a campaign) is completed, the entity 202 and hence the reporting server 212 may not desire the attribeacon app 310 of mobile devices 204 to be alerted every time a user 206 enters a physical location 208 associated with an entity 202 (e.g., one of stores of an advertiser). Accordingly, the reporting server 212 may contact the attribeacon management server 214 to request that the attribeacon management server 214 stop broadcasting the requested identifiers to the physical locations 208 associated with the entity 202 (e.g., the stores belonging to the advertiser). The attribeacon management server 214 may contact each attribeacon device 210 in the advertiser's stores and may transmit a message to each of the attribeacon devices 210 to remove the identifiers from their respective list of identification information. The attribeacon app 310 then ceases to cause those identifiers to be broadcast by the wireless transceivers 308a-308n, (e.g., Bluetooth radios) of the attribeacon devices 210.

Alternatively, the entity 202 (e.g., the advertiser) may not desire the reporting server 212 to continue collecting data on which users 206 (e.g., consumers) are located in which physical locations 208 (e.g., stores) after the notification period (e.g., campaign) has ended. The entity server 218 may be configured to transmit a message to the attribeacon management server 214 to cease broadcasting identifiers previously requested by the specific reporting server 212. Accordingly, the attribeacon management server 214 removes the identifiers in the same way.

Examples of the present disclosure may be subject to numerous variations. In one example, one attribeacon device 210 may be installed per physical location 208 associated with an entity 202 (e.g., one per store). Should the entity 202 (e.g., advertiser) wish to know not only how many users 206 (e.g., consumers) who viewed a notification (e.g., an advertisement) were induced to visit an associated physical location 208 associated with the entity 202 (the store), but how many users 206 (e.g., consumers) visited a specific portion of the physical location 208 (e.g., a specific part of the store, e.g., a certain department, or a checkout area), the attribeacon device 210 should be installed in that specific portion of the physical location 208. If different notification campaigns have different requirements for the same physical location 208, multiple attribeacon devices 210 may be installed in each physical location 208. One or more attribeacon devices 210 within each physical location 208 (e.g., store) may be configured and made available for tracking. The entity 202 (e.g., advertiser) may register with the attribeacon management server 214 to provide additional descriptive information about each attribeacon devices 210 in a single physical location 208 (e.g., store) to indicate where the attribeacon devices 210 is located in the physical location 208 (e.g., store).

In the example described above, the entity 202 (e.g., advertiser) may wish to track how many users 206 (e.g., consumers) enter any of the physical locations 208 (e.g., stores) after viewing a notification (e.g., an advertisement). If the entity (e.g., advertiser) were interested in only a subset of their physical locations 208 (e.g., stores), then when configuring a campaign, the campaign would be restricted to a subset of the physical locations 208 (stores). This may be implemented in any number of ways that comprise coordinating the entity 202, the attribeacon management server 214, and the reporting server 212, all of which involve techniques that are well known.

Over time, various parties may build catalogs of which identifiers (e.g., proximity ID, major ID, and minor IDs) are broadcast by the attribeacons devices 210 in the physical locations 208 (e.g., stores). This may be used maliciously by apps, for example, to show advertisements for competitors the store in which a consumer is currently located. Were these identifiers broadcast by fixed beacons, there would be no way to prevent this from happening other than replacing the fixed beacons. With attribeacon devices 210, the notification platform 212 may completely invalidate any catalog of beacon identifiers built by another party by cycling the identifiers to alternative identifiers and instructing attribeacon management server 214 to use the alternative identifiers. The attribeacon management server 214 may configure each attribeacon device 210 to update accordingly, and malicious apps can no longer listen for and make use of the beacon identifiers that they had previously cataloged.

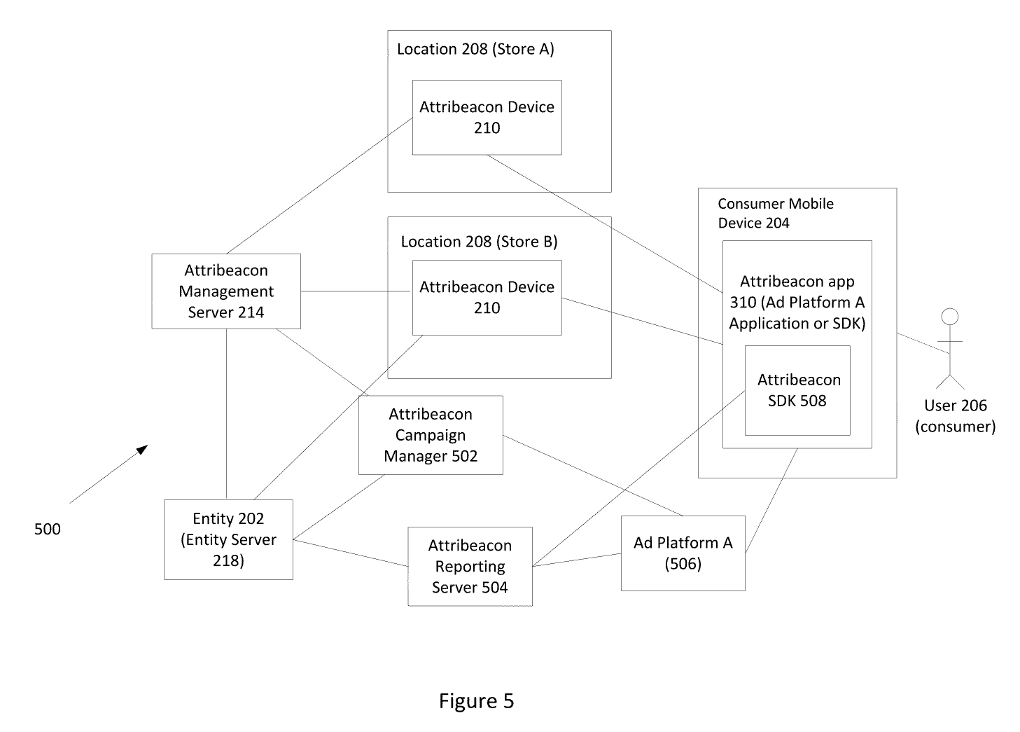

FIG. 5 is a block diagram of one example of a system 500 in which examples of the present disclosure may operate, when services provided by a reporting server 212 and an attribeacon app 310 are not available, such as for third party application developers. In FIG. 5, services formerly provided by the reporting server 212 and the processor 320 of the mobile device 204 of FIGS. 2 and 3 are offloaded to an attribeacon campaign manager 502, an attribeacon reporting server 504, and an API and associated attribeacon software development kit (SDK) 508, so that no modifications need be made to the ad platform 506 and the processor 320 of the mobile device 204. In an example, the attribeacon SDK 508 may be provided to an attribeacon app 310 to identify information about a user 206 or a mobile device 204 associated with the user 206. In this example, the entity 202 (e.g., an advertiser) may configure the notification campaigns they wish to run on the attribeacon campaign manager 502. The attribeacon campaign manager 502 may be responsible for passing configuration settings for the notification campaign to the ad platform 506, but may also be responsible for assigning a major ID for the entity 202 and a minor ID for the particular physical location 208 associated with the entity 202 (e.g., a store), then passing those instructions to the attribeacon management server 214. Thus, the ad platform 506 need not have any particular support for the attribeacon devices 210.

The attribeacon SDK 508 may load the attribeacon app 310 and may assign to the attribeacon app 310 identifying information about the user 206 or the mobile device 204 on which it is running. The attribeacon app 310/attribeacon SDK 508 may be notified by the attribeacon reporting server 504 to listen for the proximity UUID, major ID, and minor ID assigned to the campaign with the proximity UUID still generally being one in general use by the ad platform 506 so that the attribeacon app 310/attribeacon SDK 508 does not need to listen for different proximity UUIDs in order to make use of an attribeacon devices 210.

When the consumer enters the range of the attribeacon device 210, the mobile device 204 receives the transmission from the attribeacon device 210 with the Proximity UUID for which the ad platform 506 has registered interest. The attribeacon device 210 may notify the attribeacon app 310/attribeacon SDK 508 that it is now in the range of an attribeacon device 210 with the registered proximity UUID and may supply the major ID and minor ID transmitted.

The attribeacon app 310 may notify the attribeacon reporting server 504 that the particular user 206 or the mobile device 204, identified by the ID supplied by ad platform attribeacon app 310, is in the range of the supplied proximity ID, major ID, and minor ID. The attribeacon reporting server 504 may record this information.

The entity 202 (e.g., an advertiser) may wish to see reporting in the same way as they did in the main example described above. Reporting may be provided as follows: (1) The attribeacon reporting server 504 may report to the ad platform 506 the IDs of each user 206 (e.g., consumer) who visited the physical location 208 associated with the entity 202 (e.g., the store). The ad platform 506 may cross-reference this with the list of users 206 (e.g., consumers) who viewed each notification (e.g., advertisement), and may display on a display (not shown) a report of how many users 206 (e.g., consumers) who viewed each notification (e.g., advertisement) visited a physical location 208 associated with the entity 202 (e.g., a store); and (2) the attribeacon reporting server 504 may obtain from the ad platform 506 the IDs of users 206 (e.g., consumers) who viewed each notification (e.g., advertisement), or may transmit a list of users 206 (e.g., consumers) who viewed each notification (e.g., advertisement) and may receive a confirmation about which users 206 (e.g., consumers) viewed each notification (e.g., advertisement). The attribeacon reporting server 504 then uses this information to provide the same types of reports directly to the entity 202 (e.g., advertiser).

An attribeacon device 210 has many advantages over iBeacons 102. In an example, an attribeacon device 210 may be installed in a retail location or any other physical location 208 associated with an entity 202. Unlike iBeacons 102 intended for in-store experiences, the attribeacon device 210 may be plugged into a power source. Because the attribeacon device 210 has a strong power source, its radio signal can easily reach every user 206 (e.g. consumer) entering a store, and the attribeacon device 210 does not run out of power.

In an example, an attribeacon device 210 is many virtual beacons in one. If an entity 202 (e.g., an advertiser) is running a mobile campaign and wants in-store attribution, the advertiser may “pull a code” from a dashboard of an attribeacon management server 214 that transmits the code to the reporting server 212. As used herein, to “pull a code” from a dashboard of an attribeacon management server 214 refers to the entity 202 (e.g., an advertiser) going to a dashboard of the attribeacon management server 214, authorizing the social network/reporting server 212 (e.g., Facebook) to use the attribeacon device 210, and copying and pasting a key (generated by the attribeacon management server 214 for the social network/reporting server 212) into the reporting server 212. Instantly, there is a virtual beacon running with the UUID and major identifier that the reporting server 212 specifies. Minor identifiers, corresponding to the individual store locations, may be managed on either side, but automatically correspond to physical locations already in the attribeacon management server 214 (e.g., the minor values can either be specified by the attribeacon management server 214 (since attribeacon management server 214 knows the location), or an ad-network (e.g., Facebook) can first retrieve the list of locations, and based on the locations, assigns minor values according to its own scheme). As used herein, an entry in the list of locations may include, but is not limited to, a name, an address, a telephone number, and latitude/longitude coordinates.

If an advertisement network associated with the reporting server 212 or the entity (e.g., advertiser) wants the virtual beacons to be disabled, disabling may happen in real time or near real time. Since the attribeacon device 210 may be connected to the Internet (not shown), the attribeacon device 210 may report its status, so if no attribution is occurring, it is easy to determine whether it is because the attribeacon device 210 is down.

The attribeacon device 210 may solve the problem of conquesting. Since the UUID is easy to change, the advertisement network associated with the reporting server 212 or the entity 202 (e.g., advertiser) can simply request that the UUIDs be rotated. When the advertisement network associated with the reporting server 212 or the entity (e.g., advertiser) makes a configuration change (e.g., involving changing identifiers of the identification information) to the attribeacon app 310, and the attribeacon devices 210 instantly change over to employ the new identifiers of the identification information.

In an example scenario, Company A is running a mobile campaign on Facebook and wants to track its effectiveness in driving people into its stores. They have an attribeacon device 210 installed in every store. They can easily see that the attribeacons device 210 are all up and running. As a last step of setting up their campaign in Facebook, Company A is asked if they want to add in-store attribution. They say ‘yes’, then go to the attribeacon management server 214 to pull a beacon key for Facebook, and enter that key into Facebook. Facebook calls into the attribeacon management server 214 and pulls a list of Company A locations 208. Company A then tells the attribeacon management server 214 the UUID, major identifier, and minor identifier to broadcast at each location 208. The attribeacon management server 214 immediately deploys the new virtual beacons to the attribeacon device 210 in each store, and the attribeacon devices 210 are running.

The users 206 of mobile devices 204 (e.g., consumers) begin seeing the Company A advertisement on Facebook. When the users 206 receive the advertisement, their Facebook IDs are recorded. Some of the users 206 may enter the Company A stores. Because there are attribeacon devices 210 broadcasting the UUID that Facebook asked for, the consumer mobile devices 204 awaken. The Facebook app transmits to Facebook the Facebook ID of the users 206 and the UUID, major identifier, and minor identifier of the attribeacon device 210. Facebook matches these to a store location.

Company A may now see how many times its advertisements were viewed and, of the users 206 who viewed those advertisements, how many of the users 206 visited any of the store locations or particular store locations within a certain period of time after viewing the advertisement. Facebook can also break the visitors down by any demographic information that it has, since it knows which users 206 visited the store.

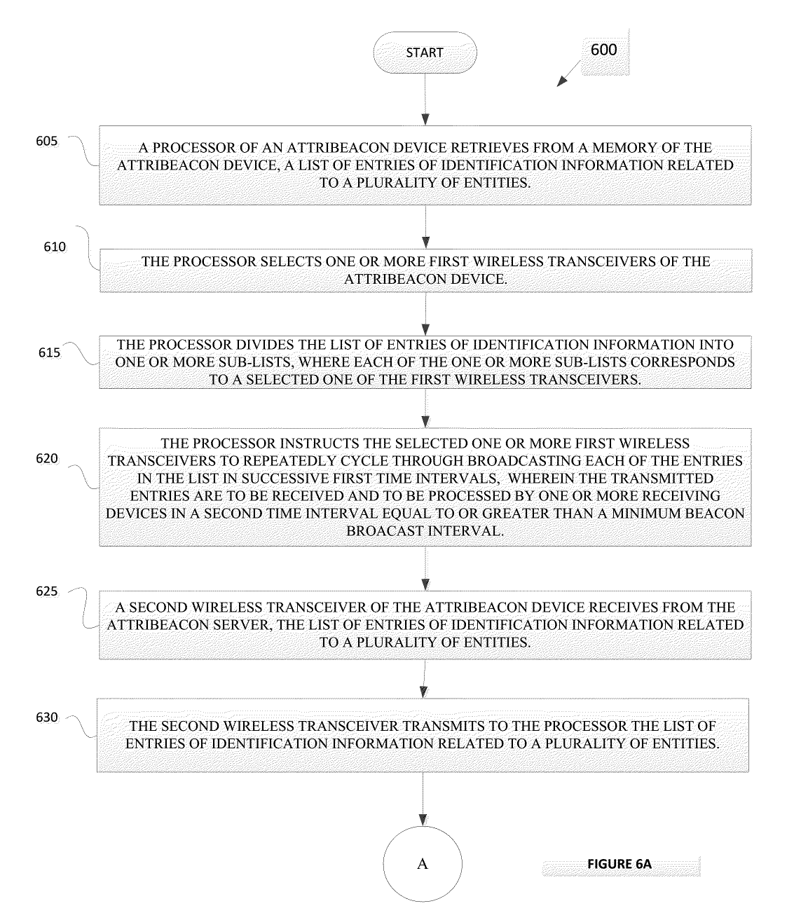

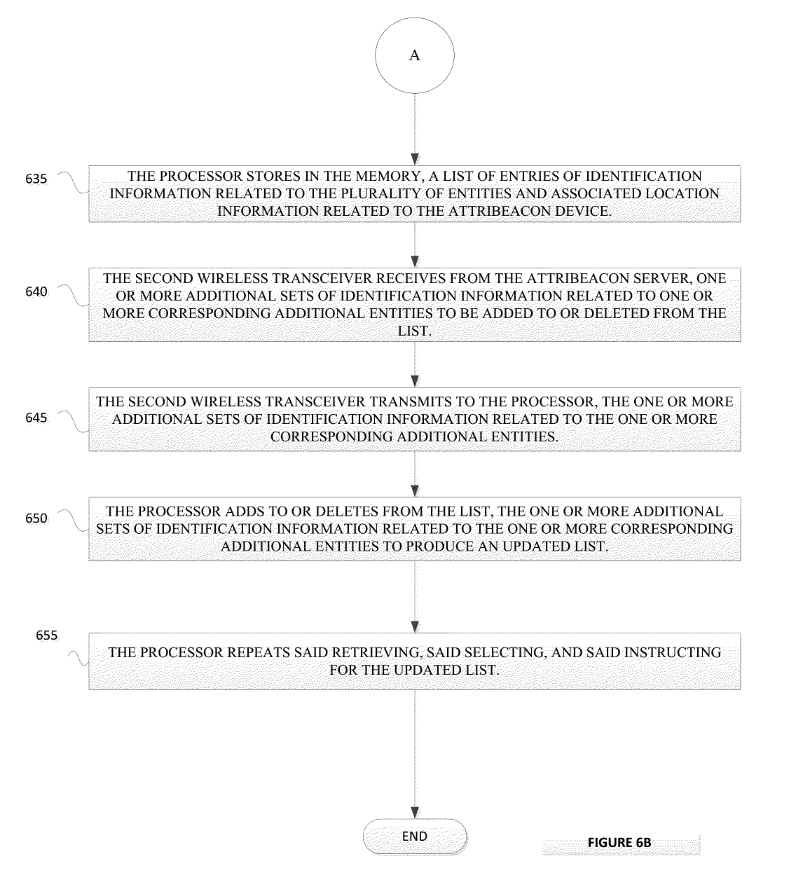

FIGS. 6A and 6B are a flow diagram illustrating an example of a method 600 of operating an attribeacon device 210. The method 600 may be performed by the processor 304 of the attribeacon device 210 of FIG. 3 and may comprise hardware (e.g., circuitry, dedicated logic, programmable logic, microcode, etc.), software (e.g., instructions run on a processing device), or a combination thereof. In one example, the method 600 is performed by processing logic (not shown) of processor 304 of the attribeacon device 210 of FIG. 3.

As shown in FIGS. 6A and 6B, at block 605, the processor 304 of the attribeacon device 210 may retrieve from a memory 302 of the attribeacon device 210, a list of entries of identification information related to a plurality of entities 202. At block 610, the processor 304 may select one or more first wireless transceivers 308a-308n of the attribeacon device 210. In an example, the one or more first wireless transceivers 308a-308n may be one or more Bluetooth wireless transceivers.

At block 615, the processor 304 may divide the list of entries of identification information into one or more sub-lists, where each of the one or more sub-lists corresponds to a selected one of the first wireless transceivers 308a-308n.

At block 620, the processor 304 may instruct the selected one or more first wireless transceivers 308a-308n to repeatedly cycle through broadcasting each of the entries in the designated sub-list in successive first time intervals. The transmitted entries are to be received and to be processed by one or more receiving devices in a second time interval, i.e., a minimum required beacon broadcast interval. In an example, the first-time interval is longer than the minimum required beacon broadcast interval (second time interval), such that the transmitted entries may be received and processed by nearby receiving devices as simultaneous and independent beacon signals that are associated with different beacon devices. In another example, the minimum required beacon broadcast interval may be equal to or greater than a sum of the successive first time intervals in the list of entries.

To program and further operate the attribeacon device 210 by an attribeacon management server 214, at block 625, a second wireless transceiver 314 of the attribeacon device 210 may receive from the attribeacon management server 214, the list of entries of identification information related to a plurality of entities 202. In an example, the second wireless transceiver 314 may be a WiFi wireless transceiver.

At block 630, the second wireless transceiver 314 may transmit to the processor 304 the list of entries of identification information related to a plurality of entities 202. At block 635, the processor 304 may store in the memory 302, a list of entries of identification information related to the plurality of entities 202 and associated location information related to the attribeacon device 210.

To program and further operate the attribeacon device 210 to add to or delete additional identification information related to additional entities 202 from the list, by an attribeacon management server 214, at block 640, the second wireless transceiver 314 may receive from the attribeacon management server 214, one or more additional sets of identification information related to one or more corresponding additional entities to be added to or deleted from the list. At block 645, the second wireless transceiver 314 may transmit to the processor 304, the one or more additional sets of identification information related to the one or more corresponding additional entities 202. At block 650, the processor 304 may add to or may delete from the list, the one or more additional sets of identification information related to the one or more corresponding additional entities 202 to produce an updated list. At block 655, the processor 304 may repeat said retrieving, said selecting, and said instructing for the updated list.

In an example, an individual entry in the list may comprise an identifier (e.g., a proximity UUID) that uniquely identifies a server that manages an individual entity in the list (e.g., the reporting server 212). In an example, the reporting server 212 may manage an advertisement campaign for the individual entity 202.

In an example, the individual entry in the list may further comprises an identifier (e.g., a major ID) that uniquely identifies the individual entity 202 in the list. In an example, the individual entity 202 in the list may correspond to an advertiser. The individual entry in the list further comprises an identifier (e.g., a minor ID) that identifies the location information related to the attribeacon device 210. The location information related to the attribeacon device 210 may be a physical location of the attribeacon device 210 (e.g., in a store of an advertiser) or a portion of the physical location of the attribeacon device 210 (e.g., a specific department of the store).

In another example, the identifier (e.g., a major ID) that uniquely identifies the individual entity 202 in the list and the identifier (e.g., a minor ID) that identifies the location information related to the attribeacon device 210 may be combined into entity-location pairs.

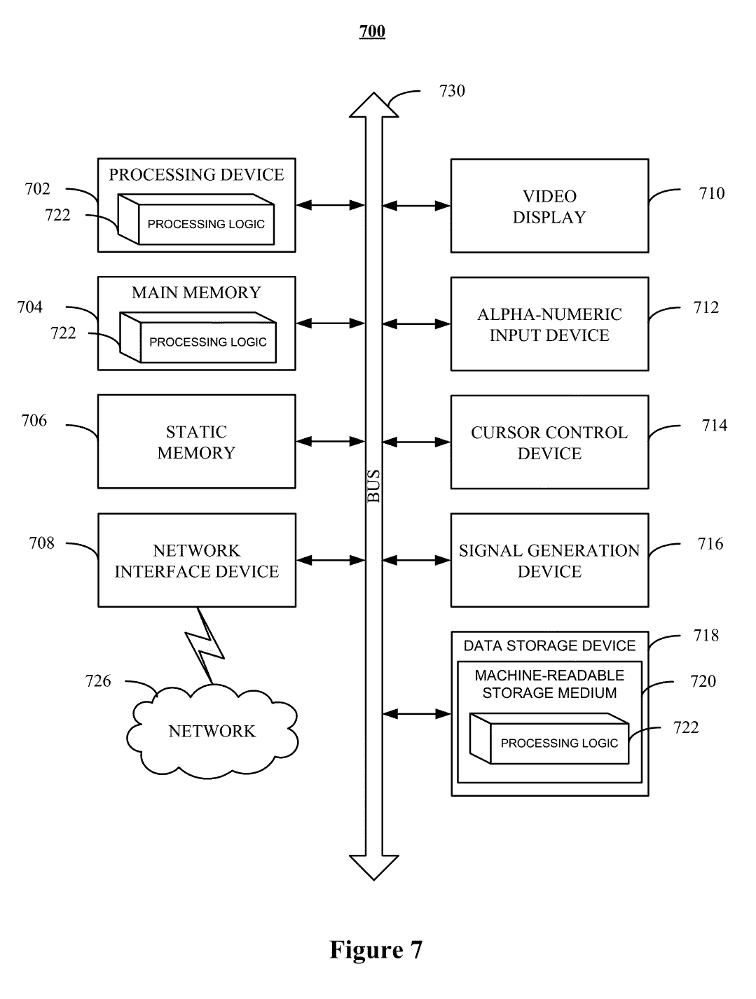

FIG. 7 illustrates a diagrammatic representation of a machine in the exemplary form of a computer system 700 within which a set of instructions, for causing the machine to perform any one or more of the methodologies discussed herein, may be executed. In alternative embodiments, the machine may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a personal digital assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 700 includes a processing device 702, a main memory 704 (e.g., read-only memory (ROM), flash memory, dynamic random access memory (DRAM) (such as synchronous DRAM (SDRAM) or Rambus DRAM (RDRAM), etc.), a static memory 706 (e.g., flash memory, static random access memory (SRAM), etc.), and a data storage device 718, which communicate with each other via a bus 730.

Processing device 702 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 702 may also be one or more special-purpose processing devices such as an application specific integrated circuit (ASIC), a field programmable gate array (FPGA), a digital signal processor (DSP), network processor, or the like. Processing device 702 is configured to execute the processing logic of the attribeacon device 210, the processing logic of the attribeacon management server 214, the attribeacon app 310, or the reporting server 212 for performing the operations and steps discussed herein.

Computer system 700 may further include a network interface device 708. Computer system 700 also may include a video display unit 710 (e.g., a liquid crystal display (LCD) or a cathode ray tube (CRT)), an alphanumeric input device 712 (e.g., a keyboard), a cursor control device 714 (e.g., a mouse), and a signal generation device 716 (e.g., a speaker).

Data storage device 718 may include a machine-readable storage medium (or more specifically a computer-readable storage medium) 720 having one or more sets of instructions (e.g., the processing logic of the attribeacon device 210, the processing logic of the attribeacon management server 214, the attribeacon app 310, or the reporting server 212) embodying any one or more of the methodologies of functions described herein. The processing logic of the attribeacon device 210, the processing logic of the attribeacon management server 214, the attribeacon app 310, or the reporting server 212 may also reside, completely or at least partially, within main memory 704 and/or within processing device 702 during execution thereof by computer system 700; main memory 704 and processing device 702 also constituting machine-readable storage media. The processing logic of the attribeacon device 210, the processing logic of the attribeacon management server 214, the attribeacon app 310, or the reporting server 212, may further be transmitted or received over a network 726 via network interface device 708.

Machine-readable storage medium 720 may also be used to store the device queue manager logic persistently. While machine-readable storage medium 720 is shown in an exemplary embodiment to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instruction for execution by the machine and that causes the machine to perform any one or more of the methodologies of the present invention. The term “machine-readable storage medium” shall accordingly be taken to include, but not be limited to, solid-state memories, and optical and magnetic media.

The components and other features described herein can be implemented as discrete hardware components or integrated in the functionality of hardware components such as ASICs, FPGAs, DSPs or similar devices. In addition, these components can be implemented as firmware or functional circuitry within hardware devices. Further, these components can be implemented in any combination of hardware devices and software components.

Some portions of the detailed descriptions are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the above discussion, it is appreciated that throughout the description, discussions utilizing terms such as “enabling”, “transmitting”, “requesting”, “identifying”, “querying”, “retrieving”, “forwarding”, “determining”, “passing”, “processing”, “disabling”, or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the present invention also relate to an apparatus for performing the operations herein. This apparatus may be specially constructed for the required purposes or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs and magnetic-optical disks, read-only memories (ROMs), random access memories (RAMs), EPROMs, EEPROMs, magnetic or optical cards, flash memory devices including universal serial bus (USB) storage devices (e.g., USB key devices) or any type of media suitable for storing electronic instructions, each of which may be coupled to a computer system bus.

The algorithms and displays presented herein are not inherently related to any particular computer or other apparatus. Various general purpose systems may be used with programs in accordance with the teachings herein or it may prove convenient to construct more specialized apparatus to perform the required method steps. The required structure for a variety of these systems will be apparent from the description above. In addition, the present invention is not described with reference to any particular programming language. It will be appreciated that a variety of programming languages may be used to implement the teachings of the invention as described herein.

It is to be understood that the above description is intended to be illustrative, and not restrictive. Many other examples will be apparent to those of skill in the art upon reading and understanding the above description. The scope of the disclosure should, therefore, be determined with reference to the appended claims, along with the full scope of equivalents to which such claims are entitled.

1. A beacon device, comprising:
a memory;
a processor, coupled to and having use of the memory;
one or more first wireless transceivers, coupled to the processor, the processor to:
retrieve, from the memory, a list of entries of identification information related to a plurality of entities;
select the one or more first wireless transceivers;
divide the list of entries of identification information into one or more sub-lists, wherein each of the one or more sub-lists corresponds to a selected one of the first wireless transceivers; and
instruct the selected one or more first wireless transceivers to repeatedly cycle through broadcasting each of the entries in the designated sub-list in successive first time intervals, wherein the transmitted entries are to be received and to be processed by one or more receiving devices in a second time interval equal to or greater than a minimum beacon broadcast interval.

2. The beacon device of claim 1, wherein the minimum required beacon broadcast interval causes the transmitted entries to be received and processed by receiving devices as substantially simultaneous and independent beacon signals that are associated with different beacon devices.

3. The beacon device of claim 1, wherein the minimum required beacon broadcast interval is equal to or greater than a sum of the successive first time intervals in the list of entries.

4. The beacon device of claim 1, further comprising:
a second wireless transceiver, coupled to the processor, the second wireless transceiver to:
receive, from a server, the list of entries of identification information related to a plurality of entities; and
transmit, by the second wireless transceiver to the processor, the list of entries of identification information related to a plurality of entities; and
the processor further to:
store, in the memory, a list of entries of identification information related to the plurality of entities.

5. The beacon device of claim 4, wherein
the second wireless transceiver is further to:
receive, from the server, one or more additional sets of identification information related to one or more corresponding additional entities to be added to or deleted from the list; and
transmit, by the second wireless transceiver to the processor, the one or more additional sets of identification information related to the one or more corresponding additional entities;
the processor further to:
add to or delete from the list the one or more additional sets of identification information related to the one or more corresponding additional entities to produce an updated list; and
repeat, by the processor, said retrieving, said selecting, and said instructing for the updated list.

6. The beacon device of claim 1, wherein an individual entry in the list comprises an identifier that uniquely identifies a server that manages the individual entity in the list.

7. The beacon device of claim 6, wherein the server that manages the individual entity in the list manages an advertisement campaign for the individual entity.

8. The beacon device of claim 5, wherein the individual entry in the list further comprises an identifier that uniquely identifies the individual entity in the list.

9. The beacon device of claim 8, wherein the individual entity in the list corresponds to an advertiser.

10. The beacon device of claim 5, wherein the individual entry in the list further comprises an identifier that identifies location information related to the beacon device.

11. The beacon device of claim 10, wherein the location information related to the beacon device is a physical location of the beacon device or a portion of the physical location of the beacon device.

12. The beacon device of claim 1, wherein a pair of identifiers in the list are combined into an identifier that represents location information related to the beacon device and an advertiser.

13. The beacon device of claim 1, wherein the one or more first wireless transceivers are one or more Bluetooth wireless transceivers.

14. The beacon device of claim 1, wherein the second wireless transceiver is a WiFi wireless transceiver.

15. The beacon device of claim 1, wherein the beacon device is powered by alternating current from a wall socket.

16. A method, comprising:
retrieving, by a processor of a beacon device from a memory of the beacon device, a list of entries of identification information related to a plurality of entities;
selecting the one or more first wireless transceivers;
dividing the list of entries of identification information into one or more sub-lists, wherein each of the one or more sub-lists corresponds to a selected one of the first wireless transceivers; and
instruct the selected one or more first wireless transceivers to repeatedly cycle through broadcasting each of the entries in the designated sub-list in successive first time intervals, wherein the transmitted entries are to be received and to be processed by one or more receiving devices in a second time interval equal to or greater than a minimum beacon broadcast interval.

17. The method of claim 16, wherein the minimum required beacon broadcast interval causes the transmitted entries to be received and processed by receiving devices as substantially simultaneous and independent beacon signals that are associated with different beacon devices.

18. The method of claim 16, wherein the minimum required beacon broadcast interval is equal to or greater than a sum of the successive first time intervals in the list of entries.

19. A non-transitory computer-readable storage medium carrying one or more sequences of instructions that, when accessed by a beacon device, causes the beacon device to perform operations comprising:
retrieving, by a processor of a beacon device from a memory of the beacon device, a list of entries of identification information related to a plurality of entities;
selecting the one or more first wireless transceivers;
dividing the list of entries of identification information into one or more sub-lists, wherein each of the one or more sub-lists corresponds to a selected one of the first wireless transceivers; and
instruct the selected one or more first wireless transceivers to repeatedly cycle through broadcasting each of the entries in the designated sub-list in successive first time intervals, wherein the transmitted entries are to be received and to be processed by one or more receiving devices in a second time interval equal to or greater than a minimum beacon broadcast interval.

20. The non-transitory computer-readable storage medium of claim 19, wherein the minimum required beacon broadcast interval causes the transmitted entries to be received and processed by receiving devices as substantially simultaneous and independent beacon signals that are associated with different beacon devices.

21. The non-transitory computer-readable storage medium of claim 19, wherein the minimum required beacon broadcast interval is equal to or greater than a sum of the successive first time intervals in the list of entries.
